(19) United States
(12) Patent Application Publication
(10) Pub. No.: US 2011/0226984 A1
(43) Pub. Date: Sep. 22, 2011

(54) HEAT-GENERATING COMPOSITION AND METHOD FOR MANUFACTURING THE SAME

(75) Inventors: Yasushi Nimi, Kiyosu-shi (JP); Yoshio Ono, Kiyosu-shi (JP); Teppei Yamakoshi, Kiyosu-shi (JP); Kiyofumi Sakai, Kiyosu-shi (JP); Yuji Kuriyama, Kiyosu-shi (JP); Haruyasu Mizutani, Kiyosu-shi (JP); Hidefumi Shibamoto, Akiruno-shi (JP)

(73) Assignee: TOYODA GOSEI CO., LTD., Kiyosu-shi (JP)

(21) Appl. No.: 13/049,025

(22) Filed: Mar. 16, 2011

(30) Foreign Application Priority Data
Mar. 19, 2010 (JP) 2010-064723
Feb. 10, 2011 (JP) 2011-027357

(51) Int. Cl. C09K 5/00; B29C 47/88

(52) U.S. Cl. 252/70; 264/234

(57) ABSTRACT

A heat-generating composition is produced by blending magnalium (A1), an oxidizing agent (B), at least one binder (C) selected from a cellulose-based water-soluble polymer and a vinyl-based water-soluble polymer, and a solvent containing water as a main component, and drying the mixture thereof. The heat-generating composition has a water content ratio of not higher than 1.0% by mass.

### BACKGROUND OF THE INVENTION

The present invention relates to a heat-generating composition with high ignitability and flammability to generate a large amount of heat, such as a heat-generating composition used for quickly heating stored gas in a hybrid inflator to high temperature, and a method for manufacturing the same.

In vehicles such as automobiles, an airbag apparatus is installed so as to inflate an airbag with gas ejected from a gas generator (inflator). The airbag apparatus is installed for protecting an occupant of the vehicle from impact caused by collision. A gas generator for an airbag apparatus is disclosed, for example, in Japanese Laid-Open Patent Publication No. 2004-149097.

The airbag apparatus disclosed in Japanese Laid-Open Patent Publication No. 2004-149097 has a substantially tubular gas generator. In the gas generator, a first chamber and a second chamber are provided. The first chamber and the second chamber are partitioned by a rupture plate in the gas generator. The first chamber stores a heat-generating composition. The second chamber stores a pressurized storage gas such as argon gas. In the gas generator, when a vehicle impact caused by collision is sensed, an igniter is firstly activated. Subsequently, the heat-generating composition in the first chamber is burned to generate high-temperature combustion gas. Thereafter, the combustion gas from the heat-generating composition breaks the rupture plate by pressure thereof and flows into the second chamber. As a result, the storage gas in the second chamber is inflated by the heat of the combustion gas, and the resulting gas mixture of the combustion gas and the storage gas is ejected through a diffuser. The gas generator ejecting the gas mixture of the combustion gas and the storage gas as described above is known as a hybrid inflator.

As a heat-generating composition used for a gas generator having a high calorific value and ignitability, a heat-generating composition containing magnalium, which is an alloy of magnesium and aluminum as a fuel component is preferably used. The heat-generating composition containing magnalium is described, for example, in Japanese Laid-Open Patent Publication No. 2006-117508 and Japanese Laid-Open Patent Publication No. 2008-030970. The heat-generating composition disclosed in Japanese Laid-Open Patent Publication No. 2006-117508 or Japanese Laid-Open Patent Publication No. 2008-030970 has high ignitability and is manufactured by blending magnalium powder as a fuel component, an oxidizing agent, and a silicone resin binder as a binder with ethanol and drying the mixture.

In manufacturing the heat-generating composition disclosed in Japanese Laid-Open Patent Publication No. 2006-117508 or Japanese Laid-Open Patent Publication No. 2008-030970, organic solvent (ethanol) is used as a solvent for blending magnalium powder, an oxidizing agent, and a binder. Extra attention is required to handle an organic solvent for ensuring safety of workers or protecting the environment. For example, in manufacturing the heat-generating composition, workers are required to wear safety protective equipment such as a protective mask and protective goggles. Consequently, using organic solvent as little as possible in manufacturing a heat-generating composition is preferable at the work site. Accordingly, a method may be employed that uses a solvent containing water as a main component instead of an organic solvent. However, a problem associated with the heat-generating composition manufactured using this type of solvent is that ignitability of the heat-generating composition is decreased in particular at low temperature (−40° C.).

### SUMMARY OF THE INVENTION

An objective of the present invention is to provide a heat-generating composition that enables easy handling during manufacture using a solvent containing water as a main component instead of an organic solvent, and inhibits the ignitability from decreasing, and a method for manufacturing the composition.

To achieve the foregoing objective and in accordance with a first aspect of the present invention, a heat-generating composition is provided that is produced by blending magnalium, an oxidizing agent, at least one binder selected from a cellulose-based water-soluble polymer and a vinyl-based water-soluble polymer, and a solvent containing water as a main component, and drying the mixture thereof. The heat-generating composition has a water content ratio of not higher than 1.0% by mass.

In accordance with a second aspect of the present invention, a method for manufacturing a heat-generating composition is provided. The method includes: blending magnalium, an oxidizing agent, and at least one binder selected from a cellulose-based water-soluble polymer and a vinyl-based water-soluble polymer with a solvent containing water as a main component; and drying the mixture produced by the blending such that the heat-generating composition has a water content ratio of not higher than 1.0% by mass.

In accordance with a third aspect of the present invention, a heat-generating composition is provided that is produced by blending boron, an oxidizing agent, at least one binder selected from a cellulose-based water-soluble polymer and a vinyl-based water-soluble polymer, 5-aminotetrazole, and a solvent containing water as a main component, and drying the mixture thereof. The heat-generating composition has a water content ratio of not higher than 0.7% by mass.

In accordance with a fourth aspect of the present invention, a method for manufacturing a heat-generating composition is provided. The method includes: blending boron, an oxidizing agent, at least one binder selected from a cellulose-based water-soluble polymer and a vinyl-based water-soluble polymer, and 5-aminotetrazole with a solvent containing water as a main component; and drying the mixture produced in the blending such that the heat-generating composition has a water content ratio of not higher than 0.7% by mass.

In accordance with a fifth aspect of the present invention, a heat-generating composition is provided that is produced by blending magnalium, an oxidizing agent, at least one binder selected from a cellulose-based water-soluble polymer and a vinyl-based water-soluble polymer, and a solvent containing water as a main component, molding the mixture thereof by extrusion molding, and subsequently drying the molded product. The heat-generating composition has a water content ratio of not higher than 1.0% by mass.

In accordance with a sixth aspect of the present invention, a method for manufacturing a heat-generating composition is provided. The method includes: blending magnalium, an oxidizing agent, at least one binder selected from a cellulose-based water-soluble polymer and a vinyl-based water-soluble polymer, and a solvent containing water as a main component; molding the mixture produced by the step of blending by extrusion molding; and drying the molded product produced by the step of molding such that the heat-generating composition has a water content ratio of not higher than 1.0% by mass.

In accordance with a seventh aspect of the present invention, a heat-generating composition is provided that is produced by blending magnalium, an oxidizing agent, at least one binder selected from a cellulose-based water-soluble polymer and a vinyl-based water-soluble polymer, boron, and a solvent containing water as a main component, and drying the mixture thereof. The boron content in the heat-generating composition is less than the content of the magnalium in the heat-generating composition. The heat-generating composition contains 10% to 50% by mass of the magnalium and boron combined, 40% to 89.5% by mass of the oxidizing agent, and 0.5% to 10% by mass of at least one binder selected from the cellulose-based water-soluble polymer and the vinyl-based water-soluble polymer. The heat-generating composition has a water content ratio of not higher than 1.0% by mass.

### DETAILED DESCRIPTION OF THE PREFERRED EMBODIMENTS

### First Embodiment

A heat-generating composition according to a first embodiment of the present invention is described below in detail.

The heat-generating composition of the first embodiment contains magnalium (A1), an oxidizing agent (B), and a binder (C). The heat-generating composition has a water content ratio of not higher than 1.0% by mass.

(A1) Magnalium is an alloy of magnesium (Mg) and aluminum (Al) and contained as a fuel component in the heat-generating composition. Preferably, the magnalium has a component ratio of Mg to Al in a range from 20:80 to 70:30, more preferably 35:65 to 65:35. The magnalium may contain one or more metal components other than Mg or Al. Examples of the other metal components include Ca, Mn, Li, Si, Sb, Sr, Zn, Zr, Sc, Y, Sn, and rare earth metals. The magnalium may contain one or more of these metal components.

The magnalium in powder form is contained in the heat-generating composition. Preferably, the magnalium has an average particle diameter in a range from 1 μm to 100 μm, more preferably in a range from 1 μm to 70 μm, furthermore preferably in a range from 1 μm to 10 μm. Preferably, the heat-generating composition has a magnalium content ratio of 10% to 50% by mass. In the present description, the average particle diameter refers to a median diameter obtained from the measured particle size distribution with a laser diffraction particle size distribution analyzer.

The oxidizing agent (B) is contained in the heat-generating composition to produce oxidation reaction of magnalium as a fuel component. A known oxidizing agent contained in heat-generating compositions may be used as the oxidizing agent. Examples include basic metal nitrates, nitrates, perchlorates, and chlorates. Examples of the basic metal nitrates include basic copper nitrate, basic cobalt nitrate, basic zinc nitrate, basic manganese nitrate, basic ferric nitrate, basic molybdenum nitrate, basic bismuth nitrate, and basic cerium nitrate. Examples of the nitrates include alkali metal nitrates such as potassium nitrate and sodium nitrate, alkaline earth metal nitrates such as strontium nitrate, and ammonium nitrate. Examples of the perchlorates include potassium perchlorate, sodium perchlorate, and ammonium perchlorate. Examples of the chlorates include potassium chlorate and sodium chlorate. The heat-generating composition may contain one or more of these oxidizing agents. In particular, use of at least one selected from nitrates or perchlorides of alkali metals and nitrates or perchlorides of alkaline earth metals is preferable, because of a high calorific value.

The oxidizing agent is contained in the heat-generating composition also in powder form. Preferably, the oxidizing agent has an average particle diameter in a range from 1 μm to 50 μm, more preferably in a range from 1 μm to 10 μm. Preferably, the heat-generating composition has an oxidizing agent content ratio of 40% to 89.5% by mass.

The binder (C) is contained in the heat-generating composition in order to improve the moldability of the heat-generating composition. The binder for use is a binder, having a proper viscosity when dissolved in water, such as a cellulose-based water-soluble polymer or a vinyl-based water-soluble polymer. Examples of the cellulose-based water-soluble polymer include carboxymethylcellulose (CMC), hydroxypropylcellulose (HPC), hydroxypropylmethylcellulose (HPMC), soluble starch, guar gum, and dextrin. Examples of the vinyl-based water-soluble polymer include polyvinyl alcohol (PVA), carboxyvinyl polymer (polyacrylic acid), and polyvinyl pyrrolidone (PVP). When the binder is used, the calorific value can be increased due to combustion of the binder itself. The heat-generating composition may contain one or more of these binders.

Preferably, the heat-generating composition has a binder content ratio of 0.5% to 10% by mass. When formed with granulation method, preferably, the heat-generating composition has a binder content ratio in a range from 0.5% to 2.0% by mass. When formed by extrusion molding, preferably, the heat-generating composition has a binder content ratio in a range from 4.0% to 8.0% by mass.

As needed, the heat-generating composition of the first embodiment may contain various known additives as long as the problem of the present invention can be solved. Examples of additives include metal oxides such as copper oxide, ferric oxide, zinc oxide, cobalt oxide, manganese oxide, molybdenum oxide, nickel oxide, bismuth oxide, silica, and alumina; metal carbonates or basic metal carbonates such as cobalt carbonate, calcium carbonate, basic zinc carbonate, and basic copper carbonate; complex compounds of metal oxides and hydroxides such as acid clay, kaolin, talc, bentonite, diatomite, and hydrotalcite; metalates such as sodium silicate, mica molybdate, and cobalt molybdate; aluminum hydroxide, magnesium hydroxide, molybdenum disulfide, calcium stearate, silicon nitride, and silicon carbide.

As needed, the heat-generating composition of the first embodiment may contain a fuel component other than magnalium as long as the problem of the present invention can be solved. Examples of the fuel component other than magnalium include boron, aluminum, magnesium, silicon, titanium, titanium hydride, and zirconium. The heat-generating composition may contain one or more of these fuel components.

When the heat-generating composition contains a fuel component other than magnalium, preferably, the content of the fuel component other than magnalium in the heat-generating composition is less than the magnalium content (i.e. less than equivalence), more preferably less than 80% of the magnalium content. In addition, preferably, the total content ratio of magnalium and fuel components other than magnalium in the heat-generating composition is 10% to 50% by mass.

The water content ratio of the heat-generating composition of the first embodiment is adjusted to be not higher than 1.0% by mass (in a range from 0.01% to 1.0% by mass). A water content ratio of not higher than 1.0% by mass leads to high ignitability and high heat-generating performance.

The heat-generating composition of the first embodiment is eventually molded into columnar or prism-shaped pellets. To form the molded product, a solvent containing water as a main component is added to the components of the heat-generating composition comprising magnalium, an oxidizing agent, and a binder for blending and kneading the mixture (blending step). The solvent containing water as a main component refers to a solvent composed of water alone or a solvent containing not less than 50% by mass of water and one or more of water-soluble organic solvents (e.g. alcohol-based organic solvent such as methanol and ethanol or ketone-based organic solvent such as acetone) as remaining components. In some cases, water-soluble organic solvent is added to the solvent for enhancing surface smoothness of the heat-generating composition formed by extrusion molding.

In the subsequent step, the mixture is molded into pellets by extrusion molding (forming step). Subsequently, the pellet-shaped molded products are dried so as to have a water content ratio of not higher than 1.0% by mass (drying step). Consequently, molded products of the heat-generating composition are obtained. Preferably, the molded product is dried in a thermostatic chamber or a vacuum desiccator.

The heat-generating composition of the first embodiment can be suitably used in a gas generator for an airbag installed in a vehicle, in particular in a hybrid inflator. In that case, since the heat-generating composition of the first embodiment has high ignitability and a high calorific value, the storage gas in the hybrid inflator can be quickly heated to high temperature. As a result, the storage gas in the hybrid inflator is inflated to flow into the airbag. Examples of the airbag include an airbag for the driver's seat, an airbag for passenger's seat, a side airbag, a curtain airbag, and a knee airbag. The heat-generating composition of the first embodiment may be used in other than gas generator for airbag, for example, in a gas generator for a pre-tensioner, a gas generator for a knee bolster, and a gas generator for a pop-up device to change a hood position. In addition, the heat-generating composition of the first embodiment may be used as an enhancer for transmitting energy of a detonator or a squib to other heat-generating composition or as an ignition agent called booster.

The operational advantages of the first embodiment are described below.

(1) The heat-generating composition is manufactured by blending magnalium, an oxidizing agent, a binder, and a solvent containing water as a main component and drying the mixture thereof. The binder is at least one binder selected from a cellulose-based water-soluble polymer and a vinyl-based water-soluble polymer. The heat-generating composition has a water content ratio of not higher than 1.0% by mass.

The composition described above uses a solvent containing water as a main component for blending magnalium, an oxidizing agent, and a binder together with a water-soluble binder as the binder. Consequently, compared to the case of using a solvent composed of organic solvents only, the composition can be handled more easily during manufacture. Although the solvent used contains water as a main component, the decrease in ignitability, in particular at low temperature (−40° C.), is inhibited by reducing the water content ratio in the heat-generating composition to not higher than 1.0% by mass.

### Second Embodiment

A second embodiment of the heat-generating composition of the present invention is described below in detail. In the description, difference from the first embodiment is mainly discussed.

The heat-generating composition of the second embodiment contains boron (A2), an oxidizing agent (B), a binder (C), and 5-aminotetrazole. The heat-generating composition has a water content ratio of not higher than 0.7% by mass. The heat-generating composition of the second embodiment is different from the heat-generating composition of the first embodiment in containing boron (A2) instead of magnalium (A1), containing 5-aminotetrazole, and having a water content ratio of not higher than 0.7% by mass of the heat-generating composition.

The heat-generating composition of the second embodiment contains boron (A2) as a fuel component. Boron is contained in powder form in the heat-generating composition. Preferably, the average particle diameter of boron is in a range from 0.1 μm to 100 μm, more preferably in a range from 0.1 μm to 50 μm, furthermore preferably in a range from 0.1 μm to 5.0 μm. Preferably, the heat-generating composition has a boron content ratio of 10% to 50% by mass, more preferably 14% to 50% by mass.

The heat-generating composition of the second embodiment contains 5-aminotetrazole as a second fuel component. Contained in the heat-generating composition together with boron, 5-aminotetrazole enhances ignitability of the heat-generating composition. Also, 5-aminotetrazole is contained in powder form in the heat-generating composition. Preferably, the average particle diameter of 5-aminotetrazole is in a range from 0.1 μm to 100 μm, more preferably in a range from 1 μm to 50 μm, furthermore preferably in a range from 1 μm to 10 μm. Preferably, the heat-generating composition has a 5-aminotetrazole content ratio of 0.01% or more and less than 5% by mass, more preferably 3% to 4.5% by mass.

The oxidizing agent (B) contained in the heat-generating composition of the second embodiment is the same as the oxidizing agent (B) contained in the heat-generating composition of the first embodiment. Preferably, the heat-generating composition has an oxidizing agent content ratio of 40% to 89.5% by mass, more preferably 40% to 85.5% by mass.

The binder (C) contained in the heat-generating composition of the second embodiment is the same as the binder (C) contained in the heat-generating composition of the first embodiment. Preferably, the heat-generating composition has a binder content ratio of 0.5% to 10% by mass. Even though molding may be performed by various methods, the binder content ratio of the heat-generating composition is the same as of the heat-generating composition of the first embodiment.

The heat-generating composition of the second embodiment may contain various kinds of known additives or other fuel components as in the case of the heat-generating composition of the first embodiment.

In the second embodiment, the water content ratio of the heat-generating composition is adjusted to not higher than 0.7% by mass (in a range from 0.01% to 0.7% by mass). The specified water content ratio of not higher than 0.7% by mass leads to high ignitability and high heat-generating performance.

The method for manufacturing the heat-generating composition of the second embodiment is the same as the method for manufacturing the heat-generating composition of the first embodiment except that different components are blended in the blending step and the composition is dried so as to have a water content ratio of not higher than 0.7% by mass in the drying step. The heat-generating composition of the second embodiment also has the same range of application as the heat-generating composition of the first embodiment.

The operational advantages of the second embodiment are described below.

(2) The heat-generating composition is manufactured by blending boron, an oxidizing agent, a binder, 5-aminotetrazole, and a solvent containing water as a main component and drying the mixture thereof. The binder is at least one binder selected from a cellulose-based water-soluble polymer and a vinyl-based water-soluble polymer. The heat-generating composition has a water content ratio of not higher than 0.7% by mass.

The composition described above uses a solvent containing water as a main component for blending boron, an oxidizing agent, a binder, and 5-aminotetrazole together with a water-soluble binder as the binder. Consequently, compared to the case of using a solvent composed of organic solvents only, the composition can be handed more easily during manufacture. Although the solvent used contains water as a main component, the decrease in ignitability, in particular at low temperature (−40° C.), can be inhibited by reducing the water content ratio in the heat-generating composition to not higher than 0.7% by mass.

Boron as a fuel component has a larger calorific value per unit mass than that of magnalium. As a result, even though a smaller amount of boron is used compared to magnalium, a calorific value equivalent to magnalium can be produced. In other words, using boron as a fuel component, the entire mass of the heat-generating composition can be reduced. Thus, the weight the heat-generating composition is reduced.

However, boron requires larger amount of oxygen for combustion compared to magnalium. Consequently, in the case of using boron, combustion circumstances or more specifically the oxygen balance needs to be exactly adjusted compared to the case of using magnalium. Accordingly, in the case that proper combustion circumstances are not present due to constraints such as capacity of the inflator, preferably magnalium is used as a fuel component. Magnalium or boron as a fuel component may be selected for use depending on the required calorific value or usage environments.

### EXAMPLES

The embodiments will be further specifically described based on each of the experimental examples below.

### <Experiment 1-1: Experiment Regarding Ignitability>

The ignitability of the heat-generating composition was evaluated. Magnalium powder (A1) as a fuel component, an oxidizing agent (B), and a (C) binder were compounded at the ratio (mass ratio) shown in Table 1. Subsequently, 20 g of solvent containing water as a main component (distilled water: ethanol=4:1) was added to 100 g of the compound, and the resulting mixture was blended and kneaded. Magnalium powder of which average particle diameter is 50 μm was used. Subsequently, the mixture obtained was molded into pellets by extrusion molding. The molded products were dried to produce columnar heat-generating compositions having an outer diameter of 1.0 mm and a length of 2.5 mm (Experimental examples 1 to 4). In Experimental examples 1 to 4, each of the heat-generating compositions had the same composition with a different drying time. As a result, in Experimental examples 1 to 4, each had a different water content ratio. The ignition time of each of the heat-generating compositions in Experimental examples 1 to 4 was measured.

The ignition time of the heat-generating composition was measured as follows. Two grams of each molded heat-generating composition of the Experimental examples was fed into an igniter (made by Nippon Kayaku Co., Ltd.). The igniter was left for 1 hour at −40° C. Subsequently, the igniter was attached to a bomb-testing device having a combustion chamber (27 cc) for measuring pressure variations therein. The bomb-testing device is shown, for example, in FIG. 9 in Japanese Laid-Open Patent Publication No. 2002-012492. Subsequently, the igniter attached to the bomb-testing device was ignited under predetermined conditions (temperature: −40° C.; current value: 1.2 mA; and energization time: 2 msec) to eject gas into the combustion chamber. The pressure variations with time in the combustion chamber were measured, and the time for producing 5% of the maximum pressure (Pmax) was recorded as ignition time. The results are shown in Table 1.

TABLE 1

| | | Ex- | | | |
|---|---|---|---|---|---|
| | | perimental | Experimental | Experimental | Experimental |
| | | example 1 | example 2 | example 3 | example 4 |
| (A) | Magnalium | 35.0 | 35.0 | 35.0 | 35.0 |
| | powder | | | | |
| (B) | KNO₃ | 59.0 | 59.0 | 59.0 | 59.0 |
| (C) | HPMC | 6.0 | 6.0 | 6.0 | 6.0 |
| | Total | 100 | 100 | 100 | 100 |

| | | | | |
|---|---|---|---|---|
| Water content | 0.4 | 0.6 | 0.8 | 1.1 |
| ratio (% by mass) | | | | |
| Ignition time | 1.0 | 1.0 | 1.0 | 1.2 |
| (msec) | | | | |

As shown in Table 1, each of the compositions in Experimental examples 1 to 3 having a water content ratio of not higher than 1.0% by mass had an ignition time of not longer than 1.1 msec, exhibiting high ignitability. In contrast, the composition in Experimental example 4 having a water content ratio of 1.1% by mass had an ignition time of longer than 1.1 msec, exhibiting lower ignitability compared to Experimental examples 1 to 3.

### <Experiment 1-2: Experiment Regarding Heat-Generating Performance (1)>

The heat-generating performance of the heat-generating composition was evaluated. Magnalium powder (A1) as a fuel component, an oxidizing agent (B), and a binder (C) were compounded at the ratio (mass ratio) shown in Table 2 to produce the heat-generating compositions of Experimental examples 5 to 13. Magnalium powder of which average particle diameter is 50 μm was used. In this experiment, the processes of adding solvent and blending to form pellets were omitted. Accordingly, the mixtures of magnalium powder, an oxidizing agent, and a binder were directly used to produce the heat-generating compositions of Experimental examples 5 to 13. The heat-generating performance of each heat-generating composition of the Experimental examples was measured.

The heat-generating performance was measured with an adiabatic calorimeter (made by Shimadzu Corporation). Initially, 1 g of each heat-generating composition of the experimental examples was placed on a sample plate in the bomb for combustion of the sample. After an ignition wire was placed in contact with the heat-generating composition, the bomb for combustion of the sample was sealed. Gas in the bomb for combustion of the sample was substituted with argon gas. Subsequently, the bomb for combustion of the sample was contained in an insulated container having an internal tank filled with water. The ignition wire was energized to ignite for the perfect combustion of the heat-generating composition. The temperature rise of the water in the internal tank of the insulated container was measured. Using the measured temperature data, the calorific value was calculated according to the following formula (I).

H=(t·W−e)/S (1)

H: calorific value (J/g)

t: temperature rise of water in internal tank (K)

W: sum of heat capacity of water in internal tank obtained from combustion of reference material (benzoic acid) and heat equivalent of calorimeter (J/K)

e: calorific value correction for contribution of ignition wire and the like (J/g)

S: mass of Experimental example (g)

TABLE 2

| | | Experimental | Experimental | Experimental | Experimental | Experimental | Experimental | Experimental | Experimental | Experimental |
|---|---|---|---|---|---|---|---|---|---|---|
| | | example 5 | example 6 | example 7 | example 8 | example 9 | example 10 | example 11 | example 12 | example 13 |
| (A) | Magnalium | 25.0 | 35.0 | 45.0 | 25.0 | 35.0 | 45.0 | 25.0 | 35.0 | 45.0 |
| | powder | | | | | | | | | |
| (B) | KNO₃ | 69.0 | 59.0 | 49.0 | | | | | | |
| | Sr(NO₃)₂ | | | | 69.0 | 59.0 | 49.0 | | | |
| | KClO₄ | | | | | | | 69.0 | 59.0 | 49.0 |
| (C) | HPMC | 6.0 | 6.0 | 6.0 | 6.0 | 6.0 | 6.0 | 6.0 | 6.0 | 6.0 |
| | Total | 100 | 100 | 100 | 100 | 100 | 100 | 100 | 100 | 100 |

| | | | | | | | | | |
|---|---|---|---|---|---|---|---|---|---|
| Calorific | 6800 | 7430 | 7220 | 6590 | 7320 | 7100 | 6480 | 8920 | 8790 |
| value (J/g) | | | | | | | | | |

As shown in Table 2, through optimization of the compounding ratio of magnalium powder to an oxidizing agent, a high calorific value of not lower than 6400 J/g was produced.

### <Experiment 1-3. Experiment Regarding Heat-Generating Performance (2)>

The heat-generating performance of the heat-generating composition was evaluated. Magnalium powder (A1) as a fuel component, an oxidizing agent (B), a binder (C), and boron powder as a fuel component other than magnalium were compounded at the ratio (ratio of mass) shown in Table 3 to produce the heat-generating compositions of Experimental examples 14 to 16. Magnalium powder of which average particle diameter is 50 μm was used. Boron powder of which average particle diameter is 0.9 μm was used. In this experiment also, the processes of adding solvent and blending to mold pellets were omitted. The heat generation of each heat-generating composition of Experimental examples was measured by the same method as Experiment 1-2.

TABLE 3

| | | Experimental | Experimental | Experimental |
|---|---|---|---|---|
| | | example 14 | example 15 | example 16 |
| (A) | Magnalium | 9.0 | 12.0 | 14.0 |
| | powder | | | |
| | Boron powder | 9.0 | 8.0 | 6.0 |
| (B) | KNO₃ | 76.0 | 74.0 | 74.0 |
| (C) | HPMC | 6 | 6 | 6 |
| | Total | 100 | 100 | 100 |

| | | | |
|---|---|---|---|
| Calorific value | 6180 | 6690 | 6450 |
| (J/g) | | | |

As shown in Table 3, the compositions containing boron powder in addition to magnalium powder produced high calorific values. In particular, the compositions of Experimental examples 15 and 16 containing a smaller amount of boron powder than that of magnalium powder produced a high calorific value of not lower than 6400 J/g. Although no data is shown, in the same experiment regarding ignitability as Experiment 1-1, the compositions containing boron powder in addition to magnalium powder also produced equivalent results as of Experimental examples 1 to 3.

### <Experiment 2-1. Experiment Regarding Ignitability>

The ignitability of the heat-generating composition was evaluated. Boron powder (A2) as a fuel component, an oxidizing agent (B), a binder (C), and 5-aminotetrazole were compounded at the ratio (ratio of mass) shown in Table 4. Subsequently, 17 g of solvent containing water as a main component (distilled water: ethanol=4:1) was added to 100 g of the compound, and the resulting mixture was blended and kneaded. Boron powder of which average particle diameter is 0.9 μm was used. Subsequently, the obtained mixture was molded into pellets by extrusion molding. The molded products were dried and subsequently treated by the addition of a predetermined amount of water to produce columnar heat-generating compositions having an outer diameter of 1.0 mm and a thickness of 2.5 mm (Experimental examples 17 to 20). In Experimental examples 17 to 20, each of the heat-generating compositions had the same composition with a different amount of water added after drying. As a result, in Experimental examples 17 to 20, each had a different water content ratio. The ignition time of each heat-generating composition in Experimental examples 17 to 20 was measured by the same method as of Experiment 1-1 described above. The results are shown in Table 4.

TABLE 4

| | | Experi- | | | |
|---|---|---|---|---|---|
| | | mental | Experimental | Experimental | Experimental |
| | | example | example | example | example |
| | | 17 | 18 | 19 | 20 |
| (A) | Boron powder | 15.0 | 15.0 | 15.0 | 15.0 |
| | 5- | 4.0 | 4.0 | 4.0 | 4.0 |
| | aminotetrazole | | | | |
| (B) | KNO₃ | 75.0 | 75.0 | 75.0 | 75.0 |
| (C) | HPMC | 6.0 | 6.0 | 6.0 | 6.0 |
| | Total | 100 | 100 | 100 | 100 |

| | | | | |
|---|---|---|---|---|
| Water content | 0.22 | 0.65 | 0.96 | 2.07 |
| ratio (% by mass) | | | | |
| Ignition time (msec) | 0.96 | 0.90 | 1.34 | 1.34 |

As shown in Table 4, the compositions of Experimental examples 17 and 18 having a water content ratio of not higher than 0.7% by mass had an ignition time of not longer than 1.1 msec, exhibiting high ignitability. In contrast, the compositions of Experimental examples 19 and 20 having a water content ratio of 0.96% by mass and 2.07% by mass respectively had an ignition time of longer than 1.1 msec, exhibiting lower ignitability compared to Experimental examples 17 and 18.

### <Experiment 2-2. Experiment Regarding Heat-Generating Performance>

Boron powder (A2) as a fuel component, an oxidizing agent (B), a binder (C), and 5-aminotetrazole were compounded at the ratio (mass ratio) shown in Table 5 to produce the heat-generating compositions of Experimental examples 21 to 23. Boron powder of which average particle diameter is 0.9 μm was used. In this experiment, the processes of adding solvent and blending to mold pellets were omitted. Accordingly, the mixtures of boron, 5-aminotetrazole, an oxidizing agent, and a binder were directly used to produce the heat-generating compositions of Experimental examples 21 to 23. The heat-generating performance of each heat-generating composition of Experimental examples was measured by the same method as in Experiment 1-2.

TABLE 5

| | | Experimental | Experimental | Experimental |
|---|---|---|---|---|
| | | example 21 | example 22 | example 23 |
| (A) | Boron powder | 10.0 | 15.0 | 20.0 |
| | 5- | 4.0 | 4.0 | 4.0 |
| | aminotetrazole | | | |
| (B) | KNO₃ | 80.0 | 75.0 | 70.0 |
| (C) | HPMC | 6.0 | 6.0 | 6.0 |
| | Total | 100 | 100 | 100 |

| | | | |
|---|---|---|---|
| Calorific value | 5433 | 6651 | 6792 |
| (J/g) | | | |

As shown in Table 5, the compositions containing boron powder as a fuel component also produced high calorific values. In particular, the composition of Experimental examples 22 or 23 containing not less than 14% by mass of boron powder produced a high calorific value of not lower than 6400 J/g.

1. A heat-generating composition produced by blending magnalium (A1), an oxidizing agent (B), at least one binder (C) selected from a cellulose-based water-soluble polymer and a vinyl-based water-soluble polymer, and a solvent containing water as a main component, and drying the mixture thereof,
wherein the heat-generating composition has a water content ratio of not higher than 1.0% by mass.

2. The heat-generating composition according to claim 1 comprising 10% to 50% by mass of the magnalium (A1), 40% to 89.5% by mass of the oxidizing agent (B), and 0.5% to 10% by mass of the at least one binder (C) selected from the cellulose-based water-soluble polymer and the vinyl-based water-soluble polymer.

3. The heat-generating composition according to claim 1, further comprising boron,
wherein the boron content in the heat-generating composition is less than the content of the magnalium (A1) in the heat-generating composition.

4. A method for manufacturing a heat-generating composition, the method comprising:
blending magnalium (A1), an oxidizing agent (B), and at least one binder (C) selected from a cellulose-based water-soluble polymer and a vinyl-based water-soluble polymer with a solvent containing water as a main component; and
drying the mixture produced by the blending such that the heat-generating composition has a water content ratio of not higher than 1.0% by mass.

5. The method for manufacturing a heat-generating composition according to claim 4, further comprising:
blending an amount of boron less than the content of the magnalium (A1) in the heat-generating composition further in the blending.

6. A heat-generating composition produced by blending boron (A2), an oxidizing agent (B), at least one binder (C) selected from a cellulose-based water-soluble polymer and a vinyl-based water-soluble polymer, 5-aminotetrazole, and a solvent containing water as a main component, and drying the mixture thereof,
wherein the heat-generating composition has a water content ratio of not higher than 0.7% by mass.

7. A method for manufacturing a heat-generating composition, the method comprising:
blending boron (A2), an oxidizing agent (B), at least one binder (C) selected from a cellulose-based water-soluble polymer and a vinyl-based water-soluble polymer, and 5-aminotetrazole with a solvent containing water as a main component; and
drying the mixture produced in the blending such that the heat-generating composition has a water content ratio of not higher than 0.7% by mass.

8. The heat-generating composition according to claim 1, wherein the oxidizing agent (B) is at least one selected from a nitrate or a perchloride of an alkali metal and a nitrate or a perchloride of an alkaline earth metal.

9. A heat-generating composition produced by blending magnalium (A1), an oxidizing agent (B), at least one binder (C) selected from a cellulose-based water-soluble polymer and a vinyl-based water-soluble polymer, and a solvent containing water as a main component, molding the mixture thereof by extrusion molding, and subsequently drying the molded product, wherein the heat-generating composition has a water content ratio of not higher than 1.0% by mass.

10. A method for manufacturing a heat-generating composition, the method comprising:
blending magnalium (A1), an oxidizing agent (B), at least one binder (C) selected from a cellulose-based water-soluble polymer and a vinyl-based water-soluble polymer, and a solvent containing water as a main component;
molding the mixture produced by the step of blending by extrusion molding; and
drying the molded product produced by the step of molding such that the heat-generating composition has a water content ratio of not higher than 1.0% by mass.

11. A heat-generating composition produced by blending magnalium (A1), an oxidizing agent (B), at least one binder (C) selected from a cellulose-based water-soluble polymer and a vinyl-based water-soluble polymer, boron, and a solvent containing water as a main component, and drying the mixture thereof; wherein:
the boron content in the heat-generating composition is less than the content of the magnalium (A1) in the heat-generating composition;
the heat-generating composition contains 10% to 50% by mass of the magnalium (A1) and boron combined, 40% to 89.5% by mass of the oxidizing agent (B), and 0.5% to 10% by mass of at least one binder (C) selected from the cellulose-based water-soluble polymer and the vinyl-based water-soluble polymer; and
the heat-generating composition has a water content ratio of not higher than 1.0% by mass.
